(19) United States
(12) Patent Application Publication
(10) Pub. No.: US 2013/0283041 A1
(43) Pub. Date: Oct. 24, 2013

(54) SERVER CERTIFICATE SELECTION

(71) Applicants: Siddharth Vajirkar, San Jose, CA (US); Jeevan Sharma, Fremont, CA (US); Swaminathan Sankar, San Jose, CA (US)

(72) Inventors: Siddharth Vajirkar, San Jose, CA (US); Jeevan Sharma, Fremont, CA (US); Swaminathan Sankar, San Jose, CA (US)

(73) Assignee: Cisco Technology, Inc., San Jose, CA (US)

(21) Appl. No.: 13/452,353

(22) Filed: Apr. 20, 2012

(51) Int. Cl. H04L 29/06

(52) U.S. Cl. 713/156

(57) ABSTRACT

In one implementation, a network device, which may be a wide area network (WAN) optimization device includes a memory, a communication interface, and a processor. The memory is configured to store a pool of server certificates. The communication interface is configured to receive a data flow for optimization by the network device. The processor is configured to access a reverse domain name lookup on a destination internet protocol (IP) address extracted from the data flow to receive a fully qualified domain name (FQDN). A matching server certificate is selected from the pool of server certificates that best matches the FQDN. The common name of the matching server certificate and the FQDN are not exact matches. Instead, the common name may be the longest string match available from the pool of certificates, or the common name may have the most address components in common out of the available pool of certificates.

### FIELD

The present disclosures relate to server certificate selection in wide area application services.

### BACKGROUND

Secure connections allow data traffic for e-commerce, online banking, voice over internet protocol (VoIP), web-based email, and other applications to traverse the Internet safely between a destination of the data traffic and a source of the data traffic without interference by unauthorized entities. Three aspects of secure connections include (1) prevention of capture of the data traffic by unauthorized entities, (2) prevention of modification of the data traffic by unauthorized entities, and (3) verification of the identity of the host.

Secure connections involve encrypted traffic using a cryptographic protocol. Example cryptographic protocols include Secure Sockets Layer (SSL) and Transport Layer Security (TLS). In some cases, devices separate from the destination of the data traffic and the source of the data traffic are authorized to receive and decrypt the data. Such devices must be configured to operate under SSL and/or TLS protocols. Manual configuration is possible and effective when a small number of domain names are authorized. However, manual configuration is not possible for a large number of domain names.

### BRIEF DESCRIPTION OF THE DRAWINGS

FIG. 1 illustrates an embodiment of a communication system for automatic server certification selection.

FIG. 2 illustrates another embodiment of a communication system for server certification selection.

FIG. 3 illustrates an example optimization device of the embodiments of FIG. 1 or FIG. 2.

FIG. 4 illustrates an example flow chart for server certificate selection.

### DETAILED DESCRIPTION

### Overview

In one aspect, a method includes receiving a data flow at a wide area network (WAN) optimization device, extracting a destination internet protocol (IP) address from the data flow, accessing a reverse domain name lookup to receive a fully qualified domain name (FQDN) from the destination IP address, and selecting a server certificate having a common name with a longest string match with the FQDN. The longest string match is less than an exact match.

In a second aspect, an apparatus includes at least a memory, a communication interface, and a processor. The memory is configured to store a plurality of server certificates. The communication interface is configured to receive a data flow for optimization by the network device. The processor is configured to extract a destination internet protocol (IP) address from the data flow and configured to select a matching server certificate from the plurality of server certificates using a fully qualified domain name (FQDN) from a reverse domain name lookup of the destination IP address. The matching server certificate has a common name less than identical to the FQDN.

In a third aspect, a non-transitory computer readable medium storing instructions that, when executed, are operable to receive a data flow at a wide area network (WAN) optimization device, extract a destination internet protocol (IP) address from the data flow, derive a unique domain name from the destination IP address, compare the unique domain name to a plurality of common names from a pool of server certificates, and select a server certificate with a common name having more address components matched to the unique domain name that other server certificates from the pool of server certificates.

### Example Embodiments

Cryptographic protocols such as Secure Sockets Layer (SSL) and Transport Layer Security (TLS) allow secure connections between server devices and client devices without risk of tampering or eavesdropping. TLS, which was formally known as SSL, is defined by the Internet Engineering Task Force (IETF) as Request for Comments (RFC) 5246 (e.g., RFC 5246 version 1.2, published August 2008). Server devices may be defined as the providers of a service, a resource, or a set of data. Client devices may be defined as the requestors of a service, a resource, or a set of data. In some implementations, the designation of client and server may be swapped or interchangeable depending on the direction of data flow. A data flow may be defined as a packet flow or a series of data packets configured to transverse a packet switched network.

The server device and client devices communicate under TLS using server certificates. A server certificate includes the server name, the certificate authority identifier, and a public encryption key. The server name may be a hostname of the server. The certificate authority identifier is a third party entity to the client and to the server that provides server certificates. The public encryption key is a widely distributed code, that corresponds to a private key that is not distributed. Commercial web browsers are pre-populated with the certificate authority certificates from the third party certificate authorities. When the browser of the client connects to the server, the browser can verify that the certificate was indeed signed by the third party entity. The browser accesses the public key inside the certificate to setup and negotiate encryption keys to encrypt the traffic to and from the client and server.

Other devices besides the client device and the server device may be authorized to receive the data flow. For example, a transparent proxy may be authorized to intercept the data flow by the client device or the server device. A transparent proxy may also be referred to as an intercepting proxy or a forced proxy. One application of transparent proxies is the optimization of a wide area network (WAN). In WAN optimization, the transparent proxy analyzes data between the client device and the server device in order to maximize throughput, bandwidth, and/or protocol optimization. Further, WAN optimization may minimize the impact of dropped packets and/or minimize the impact of congestion.

The transparent proxy is loaded with the server certificate and corresponding private key in order to intercept the flow and analyze the data for WAN optimization. When multiple servers are used, the transparent proxy is manually loaded with a server certificate for each server by an administrator.

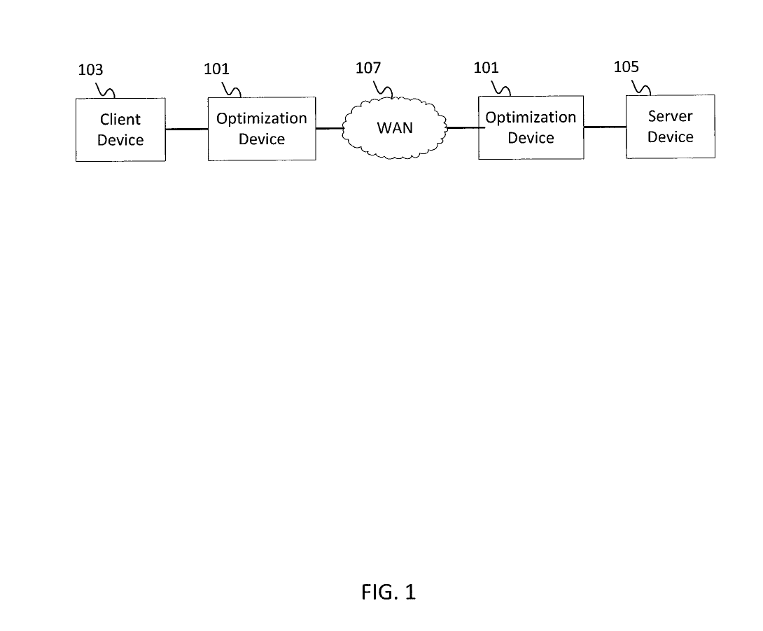

FIG. 1 illustrates an embodiment of a communication system for automatic server certification selection. The communication system includes a client device 103, a server device 105, a WAN 107, and at least two optimization devices 101. The client device 103 and server device 105 may communicate using a secure TLS connection. In one example, the communication involves a customer application such as an online banking session. In another example, the communication involves an enterprise application such as operation of a data center. The client device 103 is a one geographic location that requests data from the server device 105 in a data center at another geographic location.

An optimization device 101 is located or associated with each geographic location. The optimization device 101 may be a transparent proxy. The optimization device 101 receives a data flow. The data flow may be sent from the client device 103 to the server device 105 or from the server device 105 to the client device 103. The optimization device 101 extracts a destination internet protocol (IP) address from the data flow. Optionally, the optimization device 101 may also extract one or more of the source IP address, a destination port, and a source port. The destination port and the source port may be defined under the transmission control protocol (TCP).

The optimization device 101 queries a DNS server and performs reverse domain name lookup to receive a fully qualified domain name (FQDN) for the extracted destination IP address. The FQDN is an absolute domain name, an unambiguous domain name, or a unique domain name. In other words, a FQDN specifies an exact location in the domain name system (DNS).

The optimization device 101 selects a server certificate from a pool of certificates. Each server certificate in the pool of certificates at the optimization device 101 has a common name (CN) field that indicates the server that uses the respective server certificate. The common names may include subdomain names associated with a same domain. The optimization device 101 selects the server certificate that has a common name with a longest string match with the FQDN. The longest string match may be any match that is less than an exact match. A longest string match algorithm considers how similar the FQDN is to the common names of the server certificates. In one example, the longest string match algorithm begins with the top-level domain suffix and proceeds in order to one or more subdomain names to the left of the top-level domain suffix, and then, if possible, to a hostname to the left of the one or more subdomain names.

Optionally, the optimization device 101 may first check for an exact match between the FQDN at a common name of one of the server certificates in the pool of certificates. If no exact match exists, the optimization device 101 reverts to performing the longest string match algorithm described above.

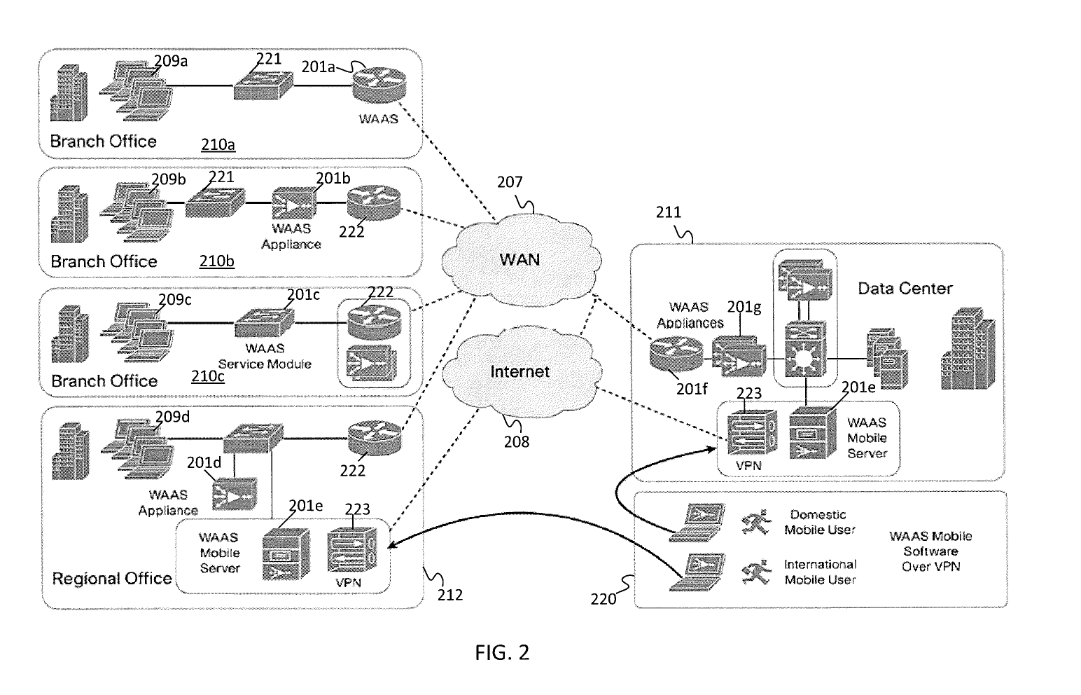

FIG. 2 illustrates another embodiment of a communication system for server certification selection. The communication system is a wide are application services (WAAS) deployment architecture across multiple geographic locations. In the implementation shown in FIG. 2, the WAAS includes a data center 211 and multiple branch offices 210a-210c that request data from the data center 211. The WAN 207 facilitates data communication between the data center and the branch offices 210a-c through a variety of protocols in lower three layers of the OSI reference model: the physical layer, the data link layer, and the network layer. The WAN 207 may communicate over or in cooperation with the Internet 208.

Each of the branch offices 210a-c, which may be in physically distinct locations, includes one or more of workstations 209a-d. The plurality of workstations 209a-d may include laptops, personal computers, handheld devices, or any computing or networking communication device. Depending on the direction of the data flow, the workstations 290a-d may be considered client devices or server devices. The branch offices 210a-c include various networking equipment 222, which may include routers, switches or other equipment. In addition, workgroup switch 221 is configured to connect to two or more network devices at layer 2 in the OSI model.

Each of the branch offices 210a-c includes an optimization device 101, which may be a standalone device or may be combined with another device. The branch office 210a includes a server 201a for WAAS as the optimization device. The branch Office 210b includes a standalone optimization device 201b as the WAAS appliance. A WAAS appliance is a standalone device. The branch Office 210c includes a WAAS service module 201c as the optimization device. WAAS service modules are software package installable on a router blade or card that is configured to be connected to a router.

The data center 211 includes multiple optimization devices 201f-e. The example shown in FIG. 2 includes a server 201f as an optimization device, a standalone optimization device 201g, and a WAAS mobile server 201e as an optimization device. The WAAS mobile server 201e may be configured to record bi-directional history of data on both the client device 103 and the server device 105. The WAAS Mobile server 201e minimizes bandwidth consumption because history is stored across all protocols, across different VPN sessions, and after a reboot.

The communication system may also include virtual private network (VPN) capabilities. A VPN server 223 is configured to provide a private connection or data flow across the public internet 208 with one or more mobile users 220. The communication system may also include a regional office 212 and mobile connections 220. The regional office 212 differs from branch offices 210a-c because the regional office 212 may also host additional branch offices as well as VPN clients. The regional office 212 may include one or more WAAS appliances 201d as well as one or more computing devices 209d.

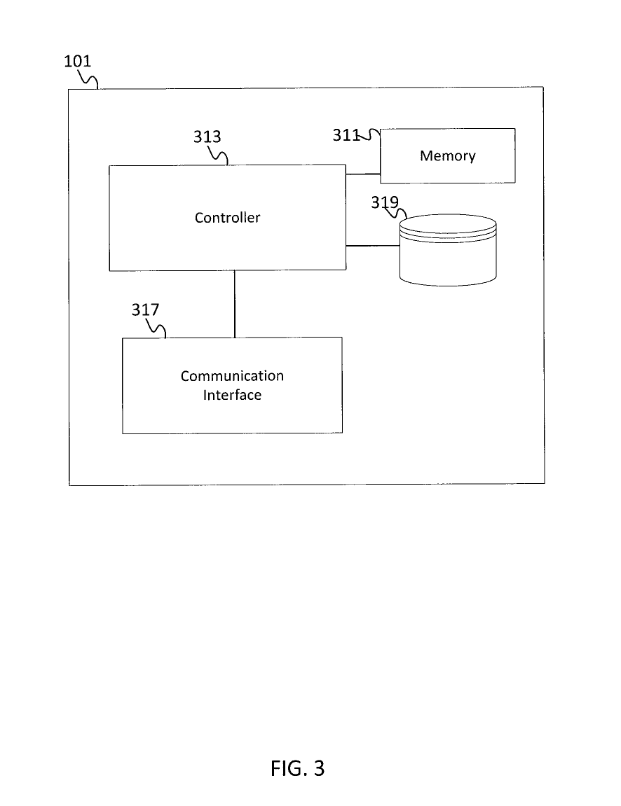

FIG. 3 illustrates an example optimization device 101 (201a-e) of the embodiments of FIG. 1 or FIG. 2. The optimization device 101 includes a memory 311, a controller 313, a communication interface 317, and a database 319. The optimization device 101 may be incorporated into any of a variety of network devices includes routers, servers, switches, or gateways.

The memory 311 is configured to store a pool of server certificates. The pool of certificates may share a field name in common. For example, the pool of certificates may include serverA.company.com, serverB.company.com, serverC.company.com, serverD.company.com, and serverE.company.com, which share the field names “company” and “corn” in common. The pool of server certificates may be received in a single file from the owner of the domain. Alternatively, the database 319 stores the pool of certificates.

The pool of server certificates may be described in a lookup table according to instructions from the owner of the domain. The lookup table lists common names from the server certificates paired with IP addresses or FQDNs. The lookup table may be stored by memory 311 or database 319. The controller 313 is configured to query the lookup table with an IP address or FQDN to retrieve a common name of the appropriate server certificate.

The communication interface 317 is configured to receive a data flow for optimization by the optimization device 101. The data flow includes at least a source IP address and a destination IP address. The communication interface 317 includes a plurality of ports. The communication interface 317 is configured to send and receive data flows or packets according to transmission control protocol (TCP) or internet protocol (IP).

The controller (or processor) 313 is configured to extract a destination IP address from the data flow and perform or access a reverse domain name lookup on the destination IP address. The reverse domain name lookup results in a FQDN that unambiguously describes the exact recipient of the data flow. The controller 313 is configured to select a matching server certificate from the pool of server certificates using the FQDN stored in the memory 311 or database 319.

In some examples, the matching server certificate may exactly match the FQDN. In other examples, the matching server certificate has a common name less than identical to the FQDN, in which case the controller 313 is configured to perform a longest string match algorithm to patch the FQDN to the best match in the pool of certificates. The longest string match may involve breaking up the common name from the server certificates and the FQDN into suffixes, subdomains, and hostnames. Suffixes, subdomains, and hostnames may collectively be referred to as address components.

In one example, the matching algorithm identifies the common name in the pool of certificates that has the most address components in common with the FQDN. In another example, the matching algorithm starts with the top-most address components, which is often the address component to the farthest right in the address and may be referred to as the most generic address component or top-level domain. The controller 313 narrows the subset of the pool of certificates to those with common names having the same top-most address components. If more than one server certificate has the same top-most address component, the controller 313 moves the next address component and again narrows the subset of the pool of certificates to those with common names have two of the same address components. If more than one server certificate has the top two address components, the controller 313 moves to the third address component. The longest string match algorithm repeats this process until one server certificate is selected as the longest string match.

The controller 313 is configured to process subsequent packets in the data flow and/or subsequent data flows. In other words, the controller 313 is configured to perform the reverse domain name lookup on another destination IP address extracted from the data flow to receive another FQDN and configured to select a matching server certificate from the pool of server certificates using the FQDN.

The controller 313 is configured to decrypt the data flow according to TLS. The server certificates include a public key signed by a certificate signing authority. The certificate signing authority is a third party with respect to the client device 103 and the server device 105. Example certificate signing authorities include Thawte, VeriSign and GoDaddy. The public key includes strings of text used to establish encryption keys. Both the client device 103 and the server device 105 can trust the certificate signing authority, which authenticates the server, and the public/private keys are used to setup encryption keys, which allows a secure connection free from eavesdropping and spoofing.

In one example, the server device 105 requests a server certificate from the certificate signing authority. The certificate signing authority provides a server certificate that incorporates the public key of the server device 105. The administrator provides the certificate to the optimization device 101 from a network device. The transfer of the certificate may be concurrent with the private key of the server device 105, and may originate with the server device 105 or another network device using file transfer protocol or another file transfer method. When the optimization device 101 intercepts data flows between the client device 103 and server device 105, the optimization device 101 is configured to decrypt the data flows using the server certificate. Specifically, the optimization device 101 (or the client device 103) encrypts a random number with the public key of the server and sends the result to the server device 105. Only the server device 105 is able to decrypt result, using the private key of the server device 105. The public/private pair of keys is used to derive encrypt and decrypt payload.

The optimization device 101 may include a list of trusted certificate signing authorities in database 319. Alternatively, the optimization device 101 may contact an online certificate status protocol (OCSP) server to determine whether or not one or more certificates are still valid and have not been compromised.

The controller 313 is configured to analyze the data flow according to an optimization algorithm. The optimization algorithm is configured to increase at least one of bandwidth, throughput, or latency. The optimization algorithm may include one or more of deduplication, compression, caching, forward error correction, protocol spoofing, traffic shaping, connection limits, simple rate limits, and/or latency optimization.

Deduplication reduces redundant data. The transfer of redundant data may be eliminated by sending references to the data rather than the actual data. Deduplication may involve the elimination of duplicate copies of data so that a single copy of the data is stored. Deduplication may be performed on the file level, the block level, the byte level, or the bit level.

Compression reduces the sizes of files or data flows that are transferred across the WAN. An example compression algorithm is a dictionary compress algorithm such as the Lempel-Ziv algorithm. The Lempel-Ziv algorithm is structures on a dynamically encoded dictionary that replaces a continuous stream of characters with codes. Other compression algorithms include ZIP, stac, and gzip.

Caching involves staging data in local storage. A proxy cache may be positioned at the WAN edge to store multiple user requests. Similar to a browser cache, the proxy cache stores frequently requested data or recently requested data. Proxy caching is beneficial in a communication system with branch offices.

Forward error correction involves inserting a loss-recovery packet for every predetermined number of packets. Forward error correction reduces the number of retransmissions needed in congested WANs. Protocol spoofing bundles multiple requests into one. Traffic shaping allows the administrator of the communication system to give certain application to take priority over others. Connection limits limit the number of connections across WAN links which prevents gridlock and denial of service attacks. Simple rate limits prevent too much bandwidth from being allocated to individual data flows or devices. Latency optimization refers to match applications with resources located the closest geographically to reduce latency between the client device 103 and the server device 105.

The memory 311 may be any known type of volatile memory or a non-volatile memory. The memory 311 may include one or more of a read only memory (ROM), dynamic random access memory (DRAM), a static random access memory (SRAM), a programmable random access memory (PROM), a flash memory, an electronic erasable program read only memory (EEPROM), static random access memory (RAM), or other type of memory. The memory 311 may include an optical, magnetic (hard drive) or any other form of data storage device. The memory 311 may be located in a remote device or removable, such as a secure digital (SD) memory card.

The memory 311 may store computer executable instructions for filtering and routing communication session requests. The controller 313 may execute computer executable instructions. The computer executable instructions may be included in computer code. The computer code may be written in any computer language, such as C, C++, C#, Java, Pascal, Visual Basic, Perl, HyperText Markup Language (HTML), JavaScript, assembly language, extensible markup language (XML) and any combination thereof.

The computer code may be stored in one or more tangible media or one or more non-transitory computer readable media for execution by the controller 313. A computer readable medium may include, but is not limited to, a floppy disk, a hard disk, an application specific integrated circuit (ASIC), a compact disk CD, other optical medium, a random access memory (RAM), a read only memory (ROM), a memory chip or card, a memory stick, and other media from which a computer, a processor or other electronic device can read.

The controller 313 may include a general processor, digital signal processor, application specific integrated circuit, field programmable gate array, analog circuit, digital circuit, server processor, combinations thereof, or other now known or later developed processor. The controller 313 may be a single device or combinations of devices, such as associated with a network or distributed processing. Any of various processing strategies may be used, such as multi-processing, multi-tasking, parallel processing, remote processing, centralized processing or the like. The controller 313 may be responsive to or operable to execute instructions stored as part of software, hardware, integrated circuits, firmware, micro-code or the like.

The communication interface 317 may include any operable connection. An operable connection may be one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other or through one or more intermediate entities (e.g., processor, operating system, logic, software). Logical and/or physical communication channels may be used to create an operable connection. As used herein, the phrases “in communication” and “coupled” are defined to mean directly connected to or indirectly connected through one or more intermediate components. Such intermediate components may include both hardware and software based components.

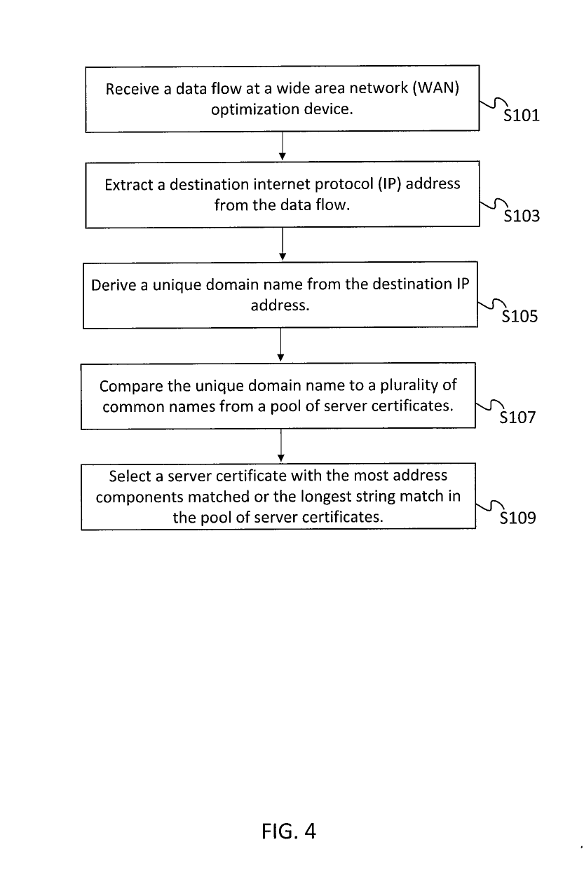

FIG. 4 illustrates an example flow chart for server certificate selection. At S101, the optimization device 101 receives a data flow from a wide area network (WAN). The optimization device 101 is a WAN optimization device. The optimization device 101 may be configured to intercept the data flow from communication between a client device 103 and a server device 105. The optimization device 101 may be authorized to intercept the data flow as part of a WAAS communication system.

At S103, the optimization device 101 extracts a destination IP address from the data flow. The optimization device 101 may also be configured to extract a source IP address and/or preferred communication ports for both the client and server devices for use with the source and destination IP addresses.

At S105, the optimization device 101 accesses a reverse domain name lookup application in order to derive a unique domain name from the destination IP address. The reverse domain name lookup application may be operated by a third part or internally to the optimization device 101 or the WAAS. The unique domain name may be a FQDN.

At S107, the optimization device 101 compares the unique domain name to a plurality of common names from a pool of server certificates. The pool of server certificates may be stored locally to the optimization device 101 or externally at a database or a WAAS server. Each of the pool of certificates includes one or more common names that identify the server device whose public key was used to create the server certificate.

At S109, the optimization device 101 performs a matching algorithm to select one of the certificates in the pool of certificates using the unique domain name derived from the destination IP address. Alternatively, the certificate may be selected based solely on the destination IP address.

In one embodiment, the matching algorithm is a longest string matching algorithm. In the longest string matching algorithm, the optimization device 101 first compares the top-level domain of the unique domain name to the top-level domain name of each of the common names in the pool of certificates. The common domain names that do not match are no longer considered by the longest string matching algorithm. The longest string matching algorithm proceeds to the next portion of the domain name, which may be referred to as a subdomain name. The optimization device 101 compares the subdomain name of the unique domain name to the subdomain names of each of the pool of certificates. The common domain names that do not match are no longer considered by the longest string matching algorithm. The longest string matching algorithm continues from right to left across the addresses to select the common name and server certificate with the longest string match.

In another embodiment, the matching algorithm operates irrespective of the level of the address components. Instead, the matching algorithm selects a select the server certificate from the pool of certificates with a common name having more address components matched to the unique domain name that the other server certificates in the pool of server certificates.

Various embodiments described herein can be used alone or in combination with one another. The foregoing detailed description has described only a few of the many possible implementations of the present embodiments. For this reason, this detailed description is intended by way of illustration, and not by way of limitation.

We claim:

1. A method comprising:
receiving a data flow at a wide area network (WAN) optimization device;
extracting, using a processor, a destination internet protocol (IP) address from the data flow;
accessing a reverse domain name lookup to receive a fully qualified domain name (FQDN) from the destination IP address; and
selecting, using the processor, a server certificate having a common name with a longest string match with the FQDN, wherein the longest string match is less than an exact match.

2. The method of claim 1, wherein selecting the server certificate comprises selecting the server certificate from a certificate pool comprising a plurality of server certificates having common names including subdomain names associated with a same domain.

3. The method of claim 1, wherein selecting the server certificate comprises:
querying a lookup table storing a certificate pool.

4. The method of claim 1, further comprising:
decrypting the data flow according to the server certificate.

5. The method of claim 1, further comprising:
receiving a second data flow at the WAN optimization device;
extracting a second destination IP address from the second data flow;
accessing the reverse domain name lookup to receive a FQDN from the second destination IP address; and
selecting a second server certificate matching the FQDN from the second destination IP address.

6. The method of claim 1, wherein receiving the data flow at the WAN optimization device comprises intercepting a cryptographic protocol data flow between a client device and a server device.

7. The method of claim 1, further comprising:
analyzing the data flow at the WAN optimization device using an optimization algorithm configured to increase at least one of bandwidth, throughput, or latency.

8. The method of claim 1, further comprising:
receiving a data file comprising a plurality of server certificates including the server certificate.

9. A network device comprising:
a memory configured to store a plurality of server certificates;
a communication interface configured to receive a data flow for optimization by the network device;
a processor configured extract a destination internet protocol (IP) address from the data flow and configured to select a matching server certificate from the plurality of server certificates using a fully qualified domain name (FQDN) from a reverse domain name lookup of the destination IP address, wherein the matching server certificate has a common name less than identical to the FQDN.

10. The network device of claim 9, wherein the memory is configured to store a look up table pairing each of the plurality of server certificates with one of a plurality of FQDNs including the FQDN.

11. The network device of claim 9, wherein the processor is configured to decrypt the data flow according to a message authentication code derived from the server certificate.

12. The network device of claim 9, wherein the processor is configured to extract a second destination IP address from the data flow, receive a second FQDN from a reverse domain name lookup of the second destination IP address, and configured to select a second matching server certificate from the plurality of server certificates using the second FQDN, wherein the second matching server certificate has a second common name that is an exact match to the second FQDN.

13. The network device of claim 9, wherein the data flow is a cryptographic protocol data flow between a client device and a server device.

14. The network device of claim 9, wherein the processor is configured to analyze the data flow using an optimization algorithm configured to increase at least one of bandwidth, throughput, or latency.

15. A non-transitory computer readable medium storing instructions that, when executed, are operable to:
receive a data flow at a wide area network (WAN) optimization device;
extract a destination internet protocol (IP) address from the data flow;
derive a unique domain name from the destination IP address;
compare the unique domain name to a plurality of common names from a pool of server certificates; and
select a server certificate with a common name having more address components matched to the unique domain name that other server certificates from the pool of server certificates.

16. The non-transitory computer readable medium of claim 15, the instructions further operable to:
decrypt the data flow according to the server certificate.

17. The non-transitory computer readable medium of claim 15, the instructions further operable to:
intercept a cryptographic protocol data flow between a client device and a server device.

18. The non-transitory computer readable medium of claim 17, the instructions further operable to:
analyze the data flow at the WAN optimization device using an optimization algorithm configured to increase the bandwidth between the client device and the server device.

19. The non-transitory computer readable medium of claim 15, the instructions further operable to:
receive a data file comprising the pool of server certificates including the server certificate.

20. The non-transitory computer readable medium of claim 15, wherein the server certificate includes a public key signed by a certificate signing authority.
